(19) United States
(12) Patent Application Publication
(10) Pub. No.: US 2019/0325649 A1
(43) Pub. Date: Oct. 24, 2019

(54) APPARATUS FOR PROVIDING VIRTUAL REALITY PICTURE CONTENT

(71) Applicant: THIRTEENTH FLOOR corp., Seoul (KR)

(72) Inventors: Young Il SONG, Incheon (KR); Jung Woo PARK, Seoul (KR); Joon Ho KIM, Gyeonggi-do (KR); Chong Kwan KIM, Gyeonggi-do (KR); Se Heon CHOI, Gyeonggi-do (KR)

(21) Appl. No.: 16/162,633

(22) Filed: Oct. 17, 2018

(30) Foreign Application Priority Data
Apr. 18, 2018 (KR) 10-2018-0045223

(51) Int. Cl. G06T 19/00

(52) U.S. Cl. CPC G06T 19/003; G06T 2219/008; G06T 19/006

(57) ABSTRACT

An apparatus for providing virtual reality picture content includes a picture storage for storing virtual reality picture content in which a plane picture and an equirectangular projection picture are combined, and a communication unit connected to be able to communicate with at least one or more virtual reality devices, through which a user can concentrate on a narrative through a plane picture, and the degree of immersion can be significantly increased through an equirectangular projection picture for a part that needs to be immersed or a part that the user wants.

### CROSS-REFERENCE TO RELATED APPLICATION AND CLAIM OF PRIORITY

This application claims priority to Korean Patent Application No. 10-2018-0045223 filed on Apr. 18, 2018 in the Korean Intellectual Property Office (KIPO), the entire disclosure of which is incorporated by reference herein.

### BACKGROUND

### 1. Field of the invention

The present invention relates to an apparatus for providing virtual reality picture content, and more particularly, to an apparatus for providing virtual reality picture content capable of expressing a narrative structure of plane picture and the sensation of immersion of an equirectangular projection picture in single content through the virtual reality picture content in which the plane picture and the equirectangular projection picture are combined.

### 2. Description of the related art

Virtual reality means an interface between a human and a computer that makes a particular environment or situation computerized and makes the person who uses it appear to interact with a real surrounding situation and environment.

In recent years, various virtual reality devices and content have been known that allow users to experience the virtual reality as described above. However, most of the content is a relatively short amount of pictures because the general virtual reality picture content cause the user to experience dizziness such as a virtual reality nausea and it is difficult to concentrate on the narration of the corresponding picture, when the user experience it for a long time.

Korean Patent Laid-Open No. 10-2017-0031962 discloses an apparatus and method for providing content based on virtual reality, in which the apparatus and method track a movement path that moves in a specific place based on a photographed image taken while moving in a known specific place, and provide virtual reality content generated by virtualizing a content image mapped to a specific location and the photographed image to a terminal device when it is reached to the specific location during the tracking of the movement path. However, due to the problems as described above, the apparatus and method also provide relatively short virtual reality content using user location information as an event generation trigger.

However, as virtual reality devices become popular, demands for more various virtual reality picture contents are growing. Therefore, there is a need for virtual reality picture content that can be concentrated for a relatively long period of time by having a narrative like a general movie and does not cause dizziness.

### SUMMARY

One or more of the embodiments of the present invention is conceived to solve the problems as described above, and are intended to provide an apparatus for providing virtual reality picture content, in which a user can concentrate on a narrative through a plane picture, and the degree of immersion can be significantly increased through an equirectangular projection picture for a part that needs to be immersed or a part that the user wants.

Other aspects of the present invention will become more apparent through the exemplary embodiments described below.

According to an aspect of the present invention, an apparatus for providing virtual reality picture content includes a picture storage for storing virtual reality picture content in which a plane picture and an equirectangular projection picture are combined, and a communication unit connected to be able to communicate with at least one or more virtual reality devices, in which the plane picture is either a monoscopic picture or a stereoscopic picture.

According to a further aspect of the present invention, the virtual reality picture content is a combination of the plane picture and the equirectangular projection picture in series according to a sequence, and when the equirectangular projection picture is transmitted to the virtual reality device by the communication unit, a notification message is generated on a surface of a picture being played.

According to another aspect of the present invention, the virtual reality picture content is a combination of the plane picture and the equirectangular projection picture in parallel according to a sequence so that the plane picture and the equirectangular projection picture match each other, and the plane picture or the equirectangular projection picture is selectively transmitted by the communication unit. The apparatus for providing virtual reality picture content further includes a virtual execution unit, in which when the plane picture or the equirectangular projection picture is transmitted by the communication unit, respectively, the equirectangular projection picture or the plane picture matched thereto, respectively, is played in real time in the virtual execution unit.

An apparatus for providing virtual reality picture content according to the present invention is advantageous in that a user can concentrate on a narrative through a plane picture, and the degree of immersion can be significantly increased through an equirectangular projection picture for a part that needs to be immersed or a part that the user wants.

Further, it is advantageous in that since the equirectangular projection picture is played only for scenes desired by a producer of virtual reality picture content or scenes desired by the user, dizziness such as a virtual reality motion sickness is minimized.

### BRIEF DESCRIPTION OF THE DRAWINGS

FIG. 1 is a configuration diagram of a system for providing virtual reality picture content according to an embodiment of the present invention.

FIGS. 2A and 2B are conceptual diagrams of picture content in a system for providing virtual reality picture content according to an embodiment of the present invention, respectively.

FIGS. 3A and 3B are views illustrating an experience of a system for providing virtual reality picture content according to an embodiment of the present invention, respectively.

### DETAILED DESCRIPTION

The present invention is capable of various transformations and may have various embodiments. Particular embodiments are illustrated in the drawings and will be described in detail in the detailed description. However, it should be understood that the present invention is not intended to be limited to the particular embodiments, but includes all modifications, equivalents, and alternatives falling within the spirit and scope of the present invention. In the following description, when it is considered that the detailed description of the related known art may blur the gist of the present invention, the detailed description thereof will be omitted.

The terms first, second, etc. may be used to describe various elements, but the elements should not be limited by the terms. The terms are used only for the purpose of distinguishing one component from another.

The term used herein is only used to describe the particular embodiments, and is not intended to limit the present invention. Unless the context clearly means otherwise, the singular expression includes plural expression. It should be understood that, herein, the terms “comprises”, “includes” or “have,” etc. are intended to specify that there is a stated feature, number, step, operation, component, part, or a combination thereof herein, and it does not exclude in advance the possibility of presence or addition of one or more other features, numbers, steps, operations, components, parts, or combinations thereof. Hereinafter, embodiments of the present invention will be described in detail with reference to the accompanying drawings.

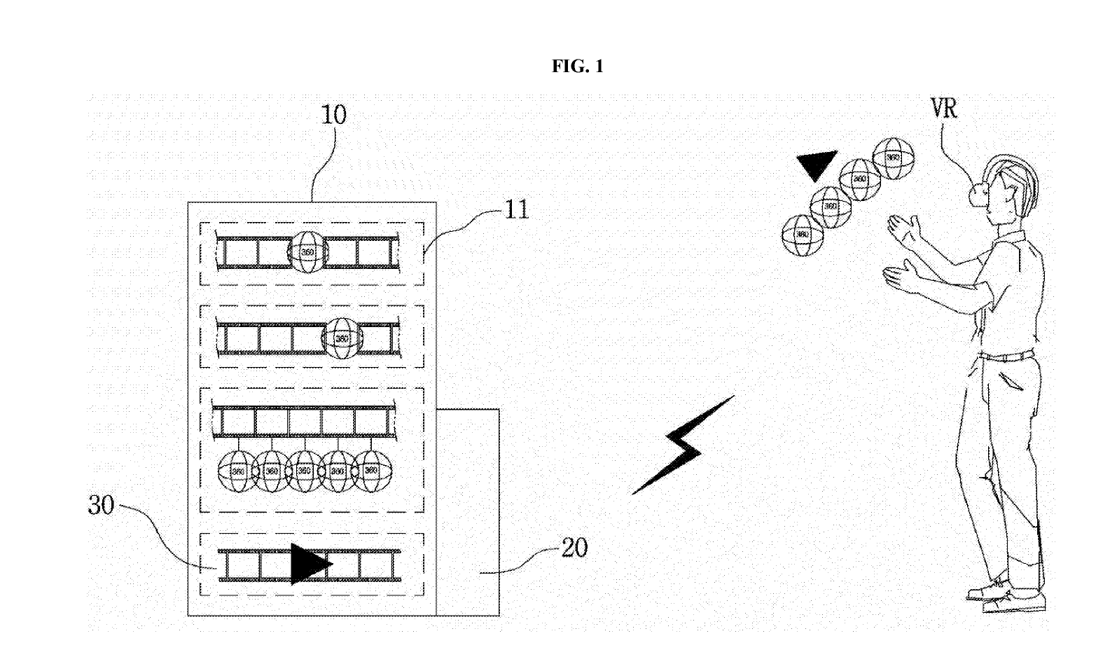

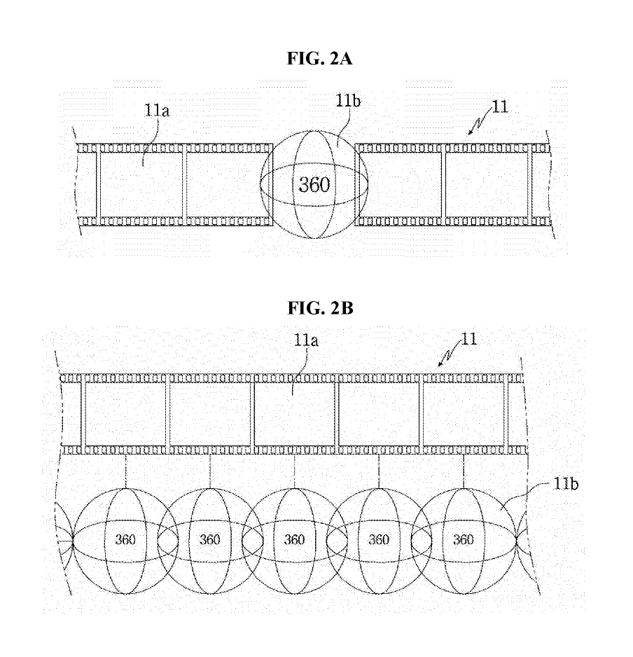

FIG. 1 is a configuration diagram of a system for providing virtual reality picture content according to an embodiment of the present invention, and FIGS. 2A and 2B are conceptual diagrams of picture content in a system for providing virtual reality picture content according to an embodiment of the present invention, respectively. The detailed configuration of the present invention will be described as below with reference to these.

An apparatus for providing virtual reality picture content includes a picture storage 10 for storing virtual reality picture content 11 in which a plane picture 11 a and an equirectangular projection picture 11b are combined; and a communication unit 20 connected to be able to communicate with at least one or more virtual reality devices VR.

The plane picture 11 a is either a monoscopic picture or a stereoscopic picture. Here, the monoscopic picture is a picture taken by one camera with one viewpoint, and it is represented in X and Y axes. The stereoscopic picture is a picture that outputs two images at the same time and implements the feeling of the depth by a user's binocular disparity, and it is represented in X, Y, and Z axes.

The equirectangular projection picture 11b represents a spherical picture as a plane picture, and has X and Y axes. The equirectangular projection picture 11b specifies a location of a subject by indicating latitude and longitude, and it is a picture according to the inference that the closer to the pole, the wider an image, and the spatial distance between longitude locations decreases as they approach the pole.

The virtual reality device VR means known various apparatuses including a virtual reality device of HMD (Head Mounted Display) type. Of course, the apparatus for providing virtual reality picture content as configured above may be formed in a web server or a portable USB device.

As shown in FIG. 2A, the virtual reality picture content 11 is a combination of the plane picture 11a and the equirectangular projection picture 11b in series according to a sequence. For example, a picture sequence in which a narration is important is implemented in the plane picture 11a, and a picture sequence in which the sensation of immersion is required is applied the equirectangular projection picture 11b.

When the equirectangular projection picture 12 is transmitted to the virtual reality device 30 by the communication unit 20, a notification message may be generated on a surface of a picture being played or a control signal may be transmitted from the communication unit 20 so that the virtual reality device 30 itself vibrates.

As shown in FIG. 2B, the virtual reality picture content 11 may be a combination of the plane picture 11a and the equirectangular projection picture 12b in parallel according to a sequence so that the plane picture and the equirectangular projection picture match each other.

The plane picture 11 or the equirectangular projection picture 12 is selectively transmitted by the communication unit 20. More specifically, the apparatus for providing virtual reality picture content further includes a virtual execution unit 30, in which when the plane picture 11a or the equirectangular projection picture 11b is transmitted by the communication unit 20, respectively, the equirectangular projection picture 11b or the plane picture lla matched thereto, respectively, may be played in real time in the virtual execution unit 30.

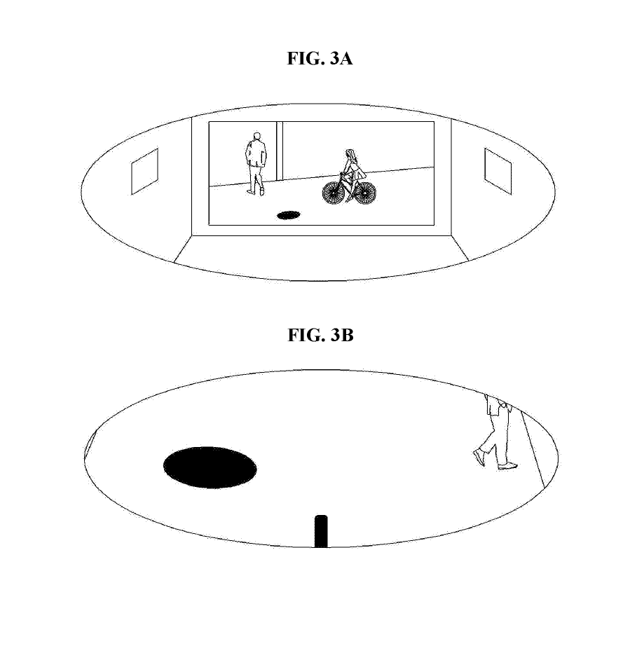

The virtual execution unit 30 prevents a picture sequence from being delayed or interrupted during the switching between the plane picture 11 a and the equirectangular projection picture 11b to drop the sensation of immersion. The virtual execution unit 30 may be included in the virtual reality device VR itself The virtual reality device VR may have a button or a separate controller for switching between the plane picture 11a and the equirectangular projection picture 11b. In addition, it may further include a motion recognition sensor so as to be switched according to a sudden motion of the user. FIGS. 3A and 3B are views illustrating an experience of a system for providing virtual reality picture content according to an embodiment of the present invention, respectively. Referring to these drawings, the following is an example that the user who wears the virtual reality device VR of HMD type experiences the virtual reality picture content provided by the apparatus for providing virtual reality picture content according to the present invention.

When the virtual reality device VR is worn and the virtual reality picture content is executed, a theater environment is provided by the equirectangular projection picture 11b so that the user can feel as if he/she is visiting a real theater. Accordingly, when the user turns his/her head and looks around, the user may experience the feeling and image like visiting the real theater with a theater screen on the front, a door on the back, or speakers on the side, and the feeling and image before a movie starts through the equirectangular projection picture 11b.

After that, when the virtual reality picture content is played, the plane picture 11a is played to develop a story that the virtual reality picture content itself has. When a scene where a girl rides a bicycle and passes a road is being played as shown in FIG. 3A, a picture sequence in which the user is actually riding a bicycle may be switched to the equirectangular projection picture 11b as shown in FIG. 3B. Accordingly, the user may experience the feeling of passing the road while riding the bicycle, and may look around a surrounding environment by turning his/her head or manipulating the virtual reality device VR.

In this way, the story may be played with the plane picture 11a for an important scene and the equirectangular projection picture 11b for a scene requiring the sensation of immersion. As another example, the user may manipulate the virtual reality device VR with respect to the desired scene and switch to the plane picture 11a or the equirectangular projection picture 11b.

The foregoing exemplary embodiments of the present invention have been disclosed for the purpose of illustration, and it would be possible for those skilled in the art to make various modifications, alterations, and additions thereof within the spirit and scope of the invention. Further, it would be appreciated that such modifications, alterations, and additions fall within the scope of the following claims.

What is claimed is:

1. An apparatus for providing virtual reality picture content, comprising:
a picture storage for storing virtual reality picture content in which a plane picture and an equirectangular projection picture are combined; and
a communication unit connected to be able to communicate with at least one or more virtual reality devices.

2. The apparatus of claim 1, wherein the plane picture is a monoscopic picture.

3. The apparatus of claim 1, wherein the plane picture is a stereoscopic picture.

4. The apparatus of claim 1, wherein the virtual reality picture content is a combination of the plane picture and the equirectangular projection picture in series according to a sequence.

5. The apparatus of claim 1, wherein the virtual reality picture content is a combination of the plane picture and the equirectangular projection picture in parallel according to a sequence so that the plane picture and the equirectangular projection picture match each other.

6. The apparatus of claim 4, wherein, when the equirectangular projection picture is transmitted to the virtual reality device by the communication unit, a notification message is generated on a surface of a picture being played.

7. The apparatus of claim 5, wherein the plane picture or the equirectangular projection picture is selectively transmitted by the communication unit.

8. The apparatus of claim 7, wherein the apparatus for providing virtual reality picture content further comprises a virtual execution unit; and
when the plane picture or the equirectangular projection picture is transmitted by the communication unit, respectively, the equirectangular projection picture or the plane picture matched thereto, respectively, is played in real time in the virtual execution unit.
